(19) United States
(12) Patent Application Publication
(10) Pub. No.: US 2007/0005400 A1
(43) Pub. Date: Jan. 4, 2007

(54) Unreported risk detector

(76) Inventors: Tom Eggenberger, Woodbury, MN (US); Jon Hemze, Cottonwood, MN (US); David Reaves, Marshall, MN (US)

Correspondence Address: Erik G. Swenson;Merchant & Gould P.C., P.O. Box 2903, Minneapolis, MN, 55402-0903, US

(21) Appl. No.: 11/173,169

(22) Filed: Jun. 30, 2005

(51) Int. Cl. G06Q 40/00

(52) U.S. Cl. 705/4

(57) ABSTRACT

A system for detecting unreported exposures is disclosed. The system includes a load unit configured to accept state records. The system also includes a risk determination unit operatively connected to the load unit. The risk determination unit has a comparison module and a rateability module. The comparison module matches an address in the state records to a state policyholder address to find an unreported exposure. The rateability module prioritizes the unreported exposure based on its correspondence to a policyholder record. The system also includes a report unit that is operatively connected to the risk determination unit. The report unit is configured to compile an output record of one or more of the unreported exposures.

### TECHNICAL FIELD

The present invention relates generally to insurance systems and more specifically to detection of unreported exposures.

### BACKGROUND

Among age groups, automobile accidents generating insurance claims most often involve a driver between 16 and 21 years of age. Because of this, insurance premiums for individuals in this age group are much higher than for other age groups. Often, a customer of an insurance company will not report a new driver in this age group on their policy immediately. Insurance companies are nonetheless obligated to pay for losses when unreported drivers cause accidents.

Insurers require policyholders to report new drivers to ensure that this increased risk is reflected in the premium paid on that policyholder's policy. However, policyholders lag in reporting new drivers on their policy, creating a period of time when insurers are exposed to the increased risk of a young driver without a resulting adjustment in premium.

To avoid such lag, insurers call their policyholders periodically when they know that a dependent has reached the age of 16 or when the insurer thinks that the dependent may have acquired a driving permit. If the dependent has obtained a permit, the policyholder is obligated to report this to the insurer. However, these phone calls require substantial effort by the insurer, and are largely inefficient in that the insurer has no specific information regarding whether the dependent has acquired a permit. Often, an insurer will call a policyholder multiple times before the dependent of that policyholder obtains a permit.

It is important for a system designed to detect unreported drivers to be accurate. Insurance companies that compare state driver licensing data to a policyholder's address find unreported drivers that are unrelated to the policyholder. This is because the unreported driver may reside with the policyholder, but not be covered by the policyholders policy. For example, many families and relatives of families may reside at the same address. These false results limit the efficiency gains in such strategies.

### SUMMARY

In accordance with the present disclosure, the above and other problems are solved by the following:

In one aspect, a system for detecting unreported exposures is disclosed. The system includes a load unit configured to accept state records. The system also includes a risk determination unit operatively connected to the load unit. The risk determination unit has a comparison module and a rateability module. The comparison module matches an address in the state records to a state policyholder address to find an unreported exposure. The state policyholder address is, for example, the address designated on the driver's license of the policyholder as found in the insurer's records. Similarly, an insurer policyholder address is, for example, the address designated on the policy of the policyholder as found in the insurer's records. The rateability module prioritizes the unreported exposure based on its correspondence to a policyholder record maintained by the insurer. The system also includes a report unit that is operatively connected to the risk determination unit. The report unit is configured to compile an output record of one or more of the unreported exposures.

According to another aspect, a system for detecting unreported drivers is disclosed. The system includes a load unit configured to accept state driver licensing data. The system also includes a risk determination unit operatively connected to the load unit. The risk determination unit includes a comparison module and a rateability module. The comparison module matches an address in the state driver licensing data to a policyholder license address to find an unreported driver. The rateability module prioritizes the unreported driver based on a correspondence to policyholder records. The system further includes a report unit operatively connected to the risk determination unit that is configured to compile an output record including one or more of the unreported drivers.

According to a further aspect, a method of reducing unreported driver exposures is disclosed. The method includes receiving state driver licensing data. The method also includes comparing the state driver licensing data to insurer license data to detect one or more unreported drivers listed in the state driver licensing data. The method further includes prioritizing the unreported drivers based on at least one rateability characteristic. The method also includes generating an output record containing a listing of one or more of the unreported drivers.

According to yet another aspect, a computer-readable medium having computer executable instructions for reducing exposure to unreported drivers is disclosed according to the present disclosure. The computer readable medium performs the previously-described method.

According to a further aspect, a method of reducing exposure to unreported drivers is disclosed. The method includes providing policyholder records. The method further includes selecting a state in which to detect unreported drivers at the same driver's license address as one or more policyholders. The method also includes selecting a rateability filter to increase accuracy of results. The method includes receiving an output report containing state driver licensing data corresponding to the unreported drivers.

### BRIEF DESCRIPTION OF THE DRAWINGS

FIG. 1 is a block diagram of a system for detecting unreported exposures according to an embodiment of the present disclosure;

FIG. 2 is a schematic representation of a computing system that can be used to implement aspects of the present disclosure;

FIG. 3 is a flowchart of the operation of a comparison unit according to an embodiment of the present disclosure;

FIG. 4 is a flowchart of the operation of a rateability unit according to an embodiment of the present disclosure;

FIG. 5 is an example of an output record according to a possible embodiment of the present disclosure;

FIG. 6 is an example of a summary report according to a possible embodiment of the present disclosure;

FIG. 7 is another example of an output record according to a possible embodiment of the present disclosure;

FIG. 8 is an unreported driver exposure reduction system according to an embodiment of the present disclosure;

FIG. 9 is an unreported driver exposure reduction system according to another possible embodiment of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The present disclosure discusses a system for detecting unreported exposures. An unreported exposure is any period of time when an insurer is exposed to an increased risk, such as the period when a new driver is not reported on their parent's automobile insurance policy but the insurer is liable for any accident. However, the invention is not limited to unreported drivers, and any unreported activity that can cause an increased risk to the insurance company is included, such as an unreported heath problem with respect to a life insurance policy, or unreported additions to a home with respect to a homeowner's policy.

In general, a system for detecting unreported exposures is disclosed. The system includes a load unit configured to accept state records. The state records can include, but are not limited to, driver licensing records from the state. The records can also be a subset of the state's driver licensing records or an index to such records. A user of the system, such as an insurer, can select one or more of these records in one or more states to detect unreported risk exposures. The load unit is also configured to accept an insurer policyholder address, which is the address designated on the insurance policy.

The system also includes a risk determination unit connected to the load unit. The risk determination unit includes a comparison module and a rateability module. The comparison module searches for matches between a state policyholder address and a state address of an unreported exposure found in the state records. For example, the state policyholder address can be a driver's license address of a policyholder found in an insurer's policyholder records. The state address of an unreported exposure can be a driver license address found in the state records of a new driver who lives in the same household as the policyholder. In the case where the addresses match, a potential unreported exposure is indicated. Multiple policyholder addresses can be used, and multiple unreported exposures can be located.

The rateability module prioritizes the unreported exposures based on their correspondence to the insurer's policyholder record for the policyholder that had a matching state address to that unreported exposure. The correspondence is determined by other criteria that increases the confidence that the unreported exposure is an exposure on the matched policy. For example, the correspondence can be a matching surname, or a matched insurance policy address to the state address of the unreported exposure, or both. Reports can also be categorized by age group of the unreported drivers, with the records prioritized within that age group.

A report unit receives the unreported exposures from the risk determination unit and compiles an output record. The output record can contain information related to both policyholders and matched unreported exposures. This information can be listed in the order in which it was prioritized by the rateability module. Unreported exposures with low correspondence to policyholder records can be listed as having low priority or can be excluded altogether by the rateability module or the report unit. A user such as an insurance company has the option to select such exclusion of records.

The output record can for example be an output record to be sent to an insurer. In this way, the insurer is able to quickly receive a listing of unreported exposures of improved accuracy. An insurer can also desire a summary report discussing the contents of the output record. Because an insurer can have a large number of policyholders and a large number of unreported drivers, a summary report provides an overview of the results derived from the system described herein.

In general, a technique of reducing unreported driver exposures is also disclosed. The technique includes receiving state driver licensing data. The technique also includes comparing the state driver licensing data to insurer license data to detect one or more unreported drivers listed in the state driver licensing data. The technique further includes prioritizing the unreported drivers based on at least one rateability characteristic. A rateability characteristic can include a match in surnames between the uninsured driver and the policyholder. A characteristic can also be a matched uninsured driver's license address to an insurer address of a policyholder. The technique also includes generating an output record containing a listing of one or more of the unreported drivers. The output record can include surname information for the policyholder, or insurance agent information. A summary report can also be generated at a user's request.

A computer-readable medium having computer executable instructions for reducing exposure to unreported drivers is also disclosed. The computer readable medium performs the above technique.

Further, a technique of reducing exposure to unreported drivers is disclosed. The technique includes providing policyholder records. The technique further includes selecting a state in which to detect unreported drivers at the same driver's license address as one or more policyholders. The technique also includes selecting a rateability filter to increase accuracy of results. The technique includes receiving an output report containing state driver licensing data corresponding to the unreported drivers. The output report can include records categorized by age group of the unreported drivers.

The systems and techniques described can be adapted to detect unreported drivers within state records. Such systems are notably useful for detecting newly licensed drivers who have not yet been reported on their parent's or other policy-holding cohabitant's insurance policy.

The systems described herein operate on state-provided data. Often, states providing such data are hesitant to release this information because of privacy concerns for state citizens. In this case, it is possible for the state itself to operate the systems and techniques as described. The state can release information to a manager of the systems in the form of the output record and the summary report. The manager can then distribute these results as requested by those interested in the results. For example, the manager could be a private operator of the system, and the interested parties can be insurers who provide the policyholder records to the state.

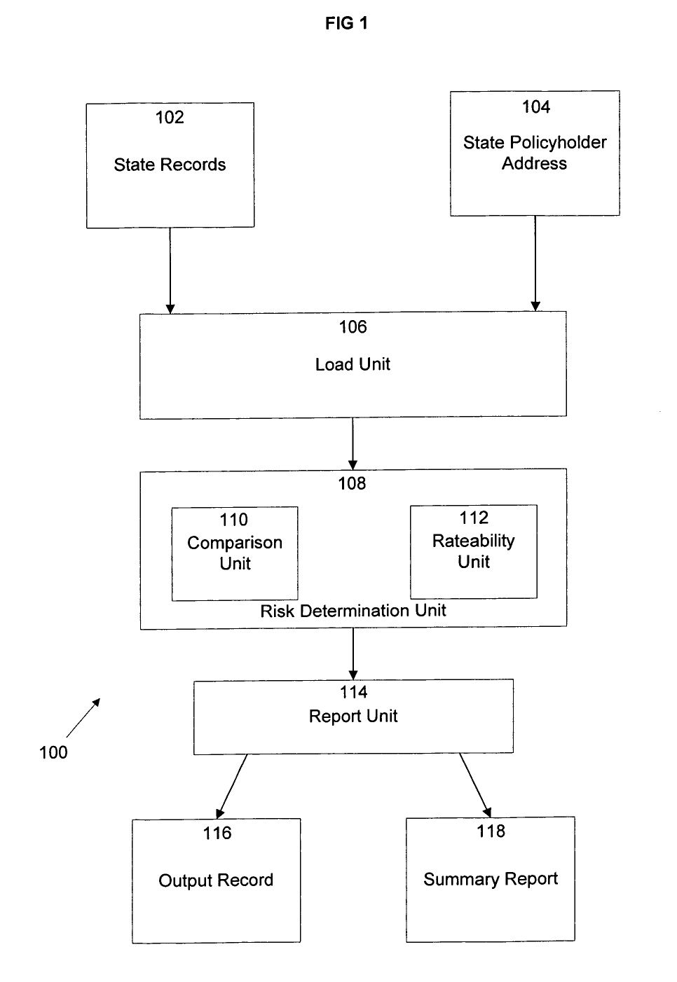

Referring now to FIG. 1, a system 100 for detecting unreported risk is shown. The system 100 receives state records 102 and state policyholder addresses 104. The state records 102 can be a full state driver licensing database or a portion thereof. The state records 102 can be in differing formats. The state policyholder addresses 104 can be a database of insurance policyholders, specifically, automobile insurance policyholders. A state policyholder address 104 can be among other data regarding a policyholder, such as name data, policy address data, property data, or family data. The state policyholder addresses 104 and state records 102 can be of types other than automobile and driver records. Other insurance policies, which might require corresponding state records, can be implemented in a similar fashion consistent with this disclosure. Policyholder data and state data should be of a corresponding nature: i.e. state health data and health insurance records, state death records and life insurance data, or state criminal records and employer insurance policies.

The state records 102 and state policyholder addresses 104 are accepted by a load unit 106. The load unit detects the format of the state records and the state policyholder addresses 104, and reformulates the data into a uniform format understandable by the remainder of the system 100. For example, the load unit 104 can have a template with multiple fields that are completed with the information as accepted from the state records 102 and the state policyholder addresses 104.

In use, it is advantageous that the load unit 104 has capabilities to accept multiple data formats. During the initial operation of the system 100, it is likely advantageous to scan a full set of state records, such as driving permit records. However, it can be inefficient for a user of the system 100 to complete a full scan monthly. In such a case, the system 100 can operate only on partial records that are updates to the original record as provided to the system. Additionally, states do not store records in uniform format. However, the flexibility of the system allows the system 100 to be operated in conjunction with multiple states using varying formats.

A risk determination unit 108 is operatively connected to the load unit 106. The risk determination unit 106 accepts the records from the load unit 104 and routes them through a comparison unit 110 and a rateability unit 112. The comparison unit 110 matches a state policyholder address 104 to one or more state records 102. For each state policyholder address 104, all state records 102 are checked for an address match. The system then repeats the process with a second state policyholder address 104.

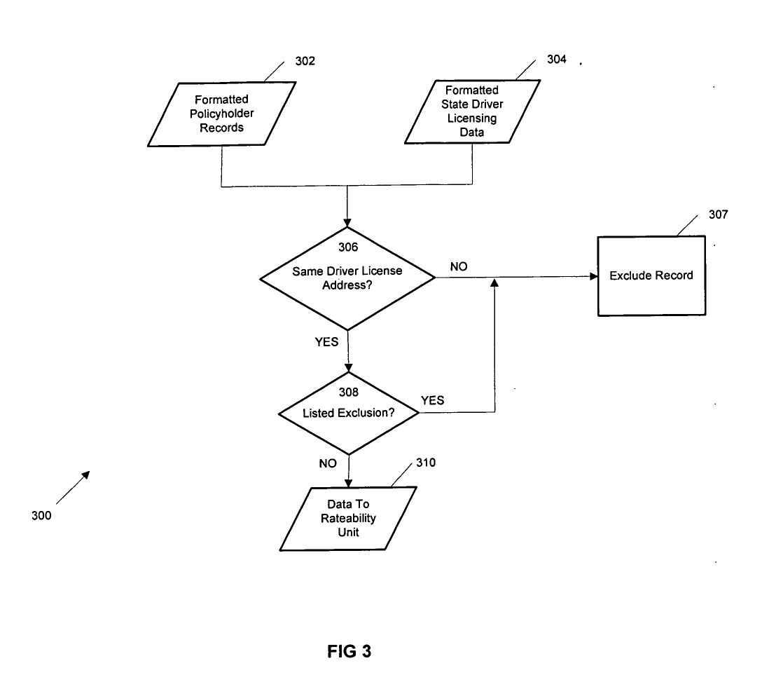

If the comparison unit 110 is able to make such a match, this signifies a possible unreported exposure. The unreported exposure can be, for example, an unreported driver found to have the same driver license address as an existing policyholder. This can occur, for example, when a new driver turns 16 years old and earns a driving permit. The state records 102 are modified by the state to reflect the new driver. So, when the system operates on those state records 102, the new driver will be detected if a parent or cohabitant has an insurance policy with a user of the system. An exemplary comparison unit operation is discussed in more detail in conjunction with FIG. 3, below.

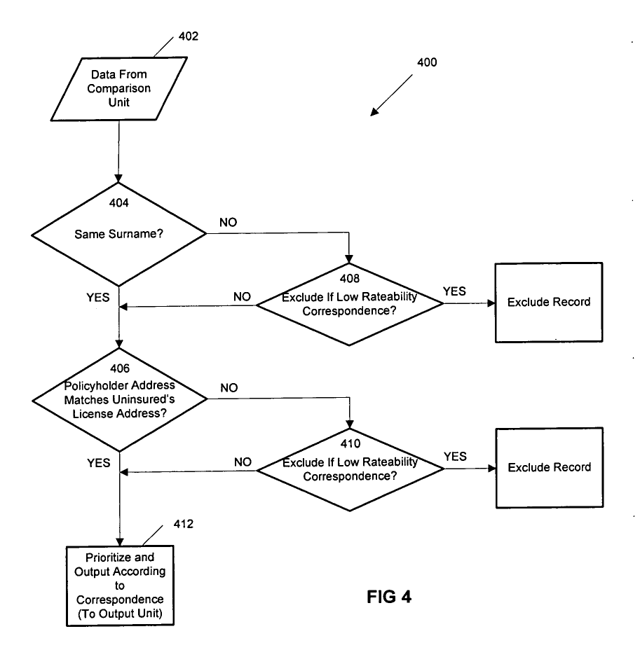

The rateability unit 112 prioritizes the detected unreported drivers according to a correspondence to a policyholder record. The policyholder record corresponds to the policyholder whose state policyholder address 104 matched the unreported driver's state record 102. Both the unreported driver's state record and the policyholder record contain more than address information. For example, the policyholder record will also contain the name of the policyholder and the address to which the policy is assigned. The state record will contain the name of the unreported driver, the birth date of the unreported driver, and other information that appears on the driver's state-issued driving permit. Selected categories of this information can be compared between the unreported driver and the policyholder to increase the confidence, or rateability, that the unreported driver should be included on the policy of the policyholder. For example, if the unreported driver and the policyholder both share the same surname, it becomes more likely that they are related and therefore share automobiles and insurance. An exemplary rateability unit 112 operation is discussed in more detail in conjunction with FIG. 4, below.

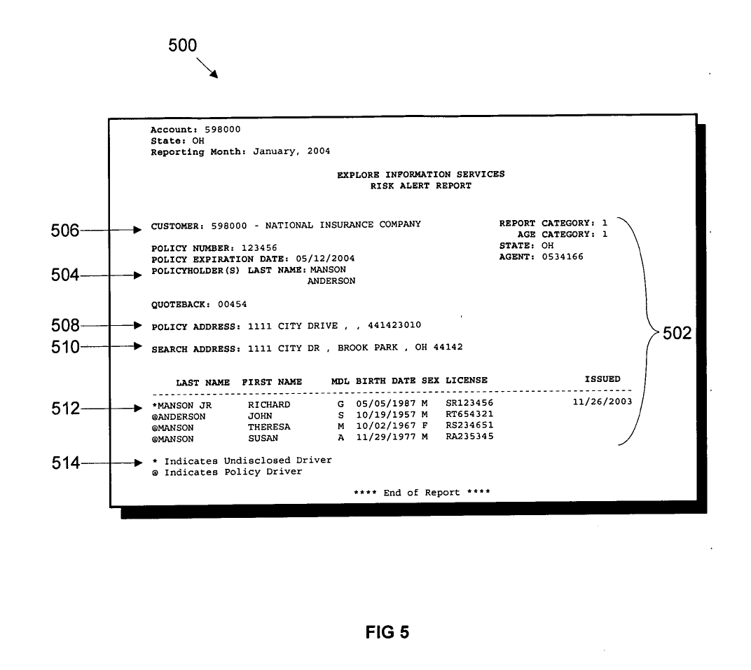

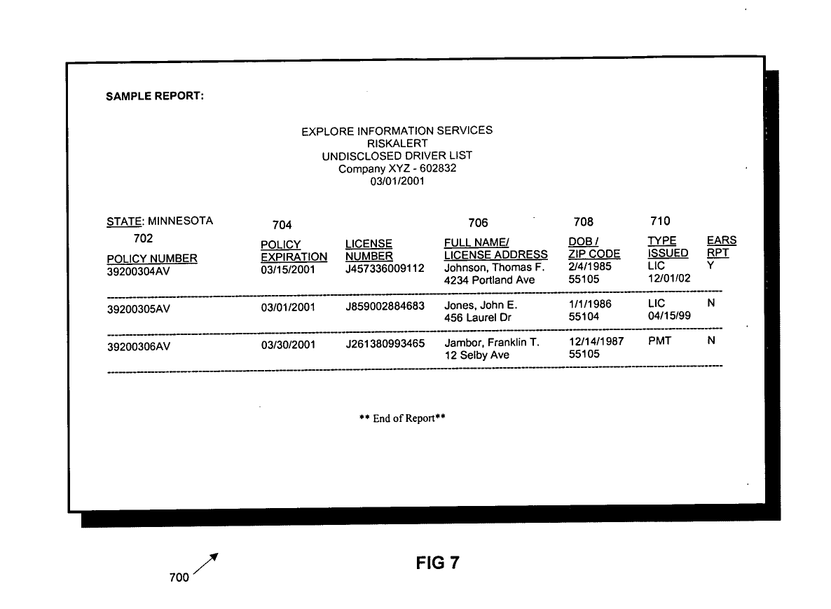

A report unit 114 is operatively connected to the risk determination unit 108. The report unit accepts data from the risk determination unit 108. The report unit is capable of generating an output record 116. The output record 116 includes information regarding the unreported exposures. It can also include various information about the policyholder, the insurer, and other policy information. Exemplary output records 116 are discussed in more detail in conjunction with FIGS. 5 and 7, below.

The report unit 114 can, upon user selection, withhold the output record 116 for a user-selectable number of months. A user of the system 100 can delay their receipt of the report to allow policyholders an opportunity to add the unreported drivers to their policy independently.

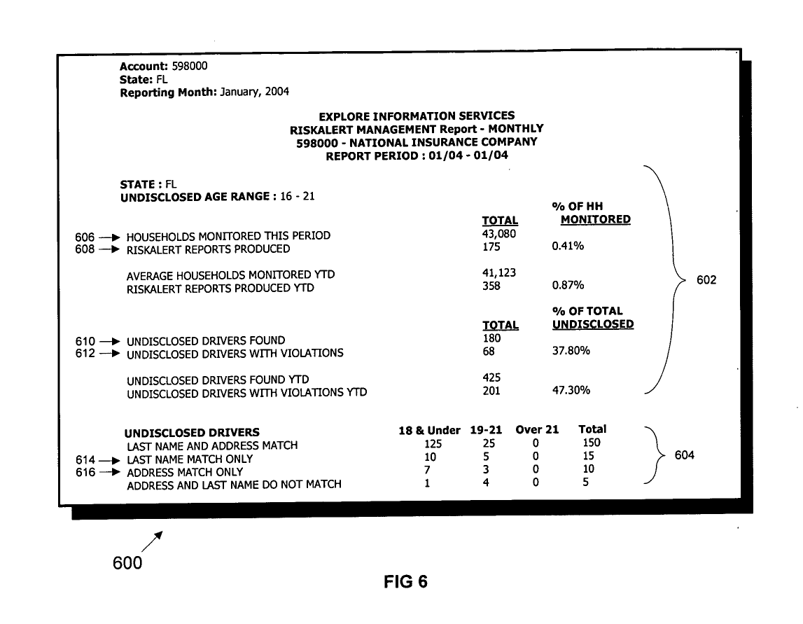

The report unit 114 can also produce a summary report 118. The summary report 118 contains information related to the output record 116. For example, the summary report 118 can contain statistics regarding the number or percentage of policyholders for which the system 100 found an unreported driver. The summary report 118 can also contain information regarding the correspondence to the policyholder record. An exemplary summary report 118 is discussed in more detail in conjunction with FIG. 6, below.

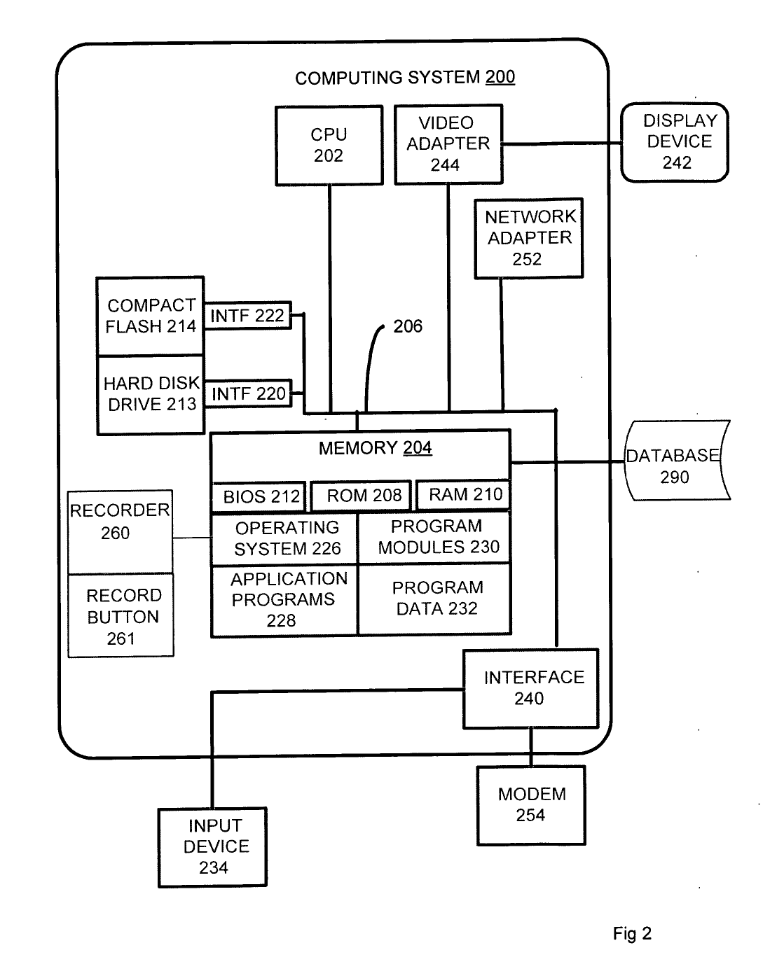

Referring now to FIG. 2, an exemplary environment for implementing embodiments of the present disclosure includes a general purpose-computing device in the form of a computing system 200 having at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller, a peripheral bus, and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media capable of storing data can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules can be stored on the hard disk 213, compact flash card 214, database 290, ROM 208, or RAM 210, including an operating system 226, one or more application programs 228, other program modules 230, and program data 232. A user can enter commands and information into the computing system 200 through an input device 234. Examples of input devices might include a keyboard, mouse, microphone, joystick, game pad, satellite dish, scanner, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, can be stored in a remote memory storage device. It will be appreciated that the network connections shown are exemplary and other means of establishing a communications link between the computing systems can be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any technique or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media can also be referred to as computer program product.

Referring now to FIG. 3, a flowchart of the operation of a comparison unit 300 is shown according to an embodiment of the present disclosure. The comparison unit 300 accepts formatted policyholder records 302 and formatted state driver licensing data 304. A comparison module 306 checks the state driver license address contained in the policyholder records 302 against the state driver licensing data 304 to find a match. If there is no match between the addresses, the record is excluded 307. If there is an address match, the person to whom the state driver licensing data corresponds can be an unreported driver that the policyholder should have included on their insurance policy. An exclusion checking module 308 determines whether the potential unreported driver is a listed exclusion of the policyholder. If this is the case, the record is excluded. The remaining matches correspond to a set of potential unreported drivers. This data 310 is the result of the comparison unit 300, and passes to a rateability unit as shown in FIG. 4.

Referring now to FIG. 4, a flowchart of the operation of a rateability unit 400 is shown according to an embodiment of the present disclosure. The rateability unit accepts data 402 from the comparison unit. The data can be, for example, the matches found in checking state driver licensing data against policyholder data from policyholder records. The rateability module performs a series of comparisons between various aspects of the policyholder record and the state record of the suspected unreported driver as detected by the comparison module. Based on these comparisons, the record can be excluded, depending on the preference of the user of the system. Alternately, the record can be ranked according to the correspondence between the records.

Specifically, a surname module 404 determines if the unreported driver has the same surname as the policyholder who shares the same driving permit address as detected by the comparison unit. If the surname of the policyholder matches the surname of the unreported driver, an insurer has higher confidence that the unreported driver should in fact be reported on the policy of the policyholder, and therefore the insurer will be more likely to choose to contact that policyholder.

Likewise, an address module 406 determines whether the unreported driver's state license address matches the policyholder address used by the insurer. If these addresses match, an insurer likewise has higher confidence that the unreported driver should in fact be reported on the policy of the policyholder.

Additionally, other correspondences and corresponding modules can be used consistently with this disclosure. The actual correspondence used by the correspondence unit depends on what data is available in both the state records and the policyholder records.

One or more exclusion modules 408, 410 remove the record from the list of unreported drivers based on the preference of a user of the system. The user, usually an insurer, can select how results are reported. Depending on the resources available to the insurer, it can choose to exclude records of lower correspondence, such as those where the surname and address modules 404, 406 do not find a match. The exclusion modules 408, 410 can alternately be executed within the output module (not shown) to the same effect consistent with the present disclosure. In this alternate embodiment, all records are prioritized and sent to the output module, which excludes the desired records according to user preferences.

A prioritization module 412 accepts the records as prioritized or excluded based on the correspondence tests and sends these prioritized records to the report unit, which generates the output record. In this way, one or more of these correspondences can be used to prioritize or exclude records.

Referring now to FIG. 5, an entry from an output record 500 is shown according to a possible embodiment of the present disclosure. The output record 500 contains policy information 502. The policy information 502 includes a policyholder name 504, a customer name 506, a policy address 508, a search address 510, unreported driver data 512, and a driver status indicator 514. The policyholder name 504 contains at least the surname of the policyholder used in the rateability unit, described in conjunction with FIG. 4. The customer name 506 is, for example, a name of an insurer or customer number of an insurer. The policy address 508 is the address that the insurer uses to send correspondence to the policyholder, and is, for example, the address that relates to the insurance rates for automobile coverage. The search address 510 is the driving permit address of the policyholder, and is the address used by the comparison unit to initially find the unreported drivers. The unreported driver data 512 includes at least part of the name of the unreported driver. The data 512 can also include the birthdate of the unreported driver, the gender of the driver, the issue date of that person's driving permit, and the state permit number. The driver status indicator 514 provides a visual indicator on the report denoting which driver or drivers among those listed as residing at the address are unreported. This indicator is particularly useful when the output record 500 is configured as presently disclosed, with reported and unreported drivers listed within an entry corresponding to the policyholder.

An output record 500 can include a large number of entries corresponding to a similar number of unreported drivers or policyholders to whom one or more unreported drivers correspond. These entries can be listed in a variety of orders. The entries can be listed in an order according to a correspondence between the policyholder and the unreported driver, as discussed in conjunction with the rateability unit of FIG. 4. The entries can also be listed by age group of the unreported drivers. The age group entries can be chosen by a user of the systems described herein, such as an insurer, to ensure that young drivers are added to insurance policies. Although an older driver can have a greater correspondence to a policyholder, the older driver is less likely to be involved in an accident than a new driver. In one example, a new driver can have a lower correspondence (no surname or address match as in FIG. 4), but due to the much higher risk of generating an insurance claim the user may want to group and focus on young drivers. Within each age group, the entries can also be prioritized according to the correspondence between the policyholder and unreported driver records.

Referring now to FIG. 6, a summary report 600 is shown according to a possible embodiment of the present disclosure. The summary report 600 includes report information 602 and rateability statistics 604. The report information 602 can include a variety of information, such as the number of households monitored 606, the number of reports produced 608, the number of unreported drivers found 610, and the number of unreported drivers found that had violations listed in their driving record 612. The rateability statistics 604 can include the number of records where a surname match was found 614, the number of records with an address match 616, or a combination thereof. The rateability statistics 604 can also include other information, depending on the rateability factors used in the rateability unit.

The summary report 600 provides a convenient way for users of the systems described herein to see the results quickly. The user, for example an insurer, may want to know how many unreported drivers were found, or may want to know the per policyholder rate of unreported drivers. These statistical compilations demonstrate the value of the systems described to a user.

Referring now to FIG. 7, an output record 700 is shown according to another possible embodiment of the present disclosure. In this example, the output record 700 is abbreviated (in comparison to the output record described in conjunction with FIG. 5), and could for example include the policy number 702, the policy expiration date 704, the undisclosed driver 706, their date of birth 708, and the date the driving permit was issued 710.

The output records 500, 700 (in FIGS. 5 and 7, respectively) are only two of many possible configurations of output records generated consistent with the present disclosure. For example, a record of multiple states could be compiled based upon accesses of different state driving records. Also, further information about the unreported driver could be included to the extent available, such as their driving record. Further information about the policyholder could be included as well, including the automobiles insured, the coverage limits, and other options common to insurance policies.

Further, the output records 500, 700 can be of a number of different formats. For example, the records can be a printed record or a data file of a variety of formats, such as a text file, a Microsoft Word document, a WordPerfect Document, a hypertext markup language (HTML) document or a different proprietary format. The record can be incorporated into one file or a series of files. The file can include a wide variety of information about the unreported driver and the matched policyholder, and can be limited only by the thoroughness of the initial input data received from the state and from the insurer.

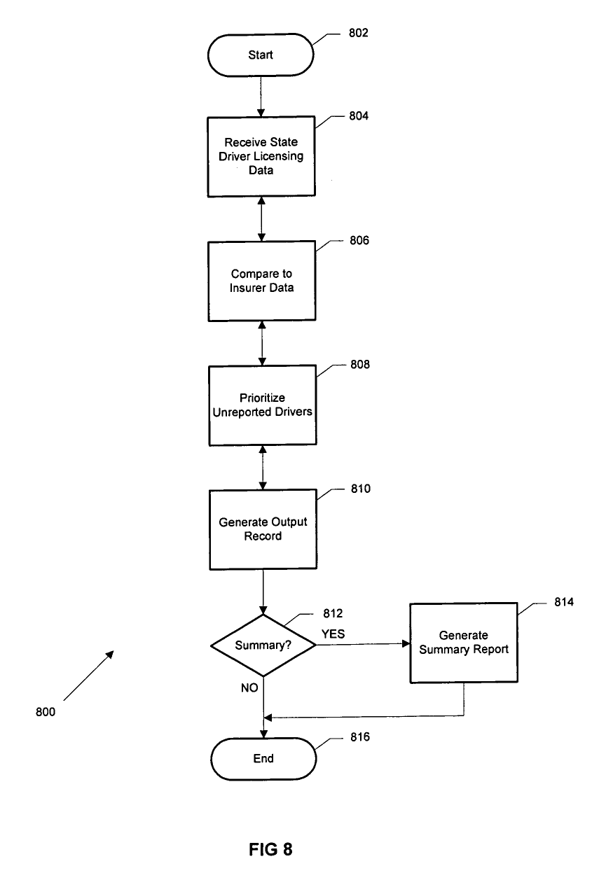

Referring now to FIG. 8, an unreported driver exposure reduction system 800 is shown according to an embodiment of the present disclosure. The system commences with a start operation 802.

An operation 804 for receiving state driver licensing data is executed. The operation 804 can accept data in a variety of formats so that the system 800 can operate with a wide variety of states, which have differing data formats. The operation 804 can accept a full database of state driver licensing data. Alternately, the operation can accept a pointer to a state-maintained database of the driver licensing data. The operation could alternately accept only an updated subset of the state driver licensing data since the last time the system was run for data in that state.

A comparison operation 806 compares insurer data to the state driver licensing data. The state driver licensing data contains names and corresponding addresses, permit numbers, dates of issuance, and driving violations for state-licensed drivers. The comparison operation 806 searches through state driver licensing data to find an address that matches the state driving permit address of a policyholder of the insurer. This comparison finds suspected unreported drivers among the state driver licensing data. The comparison operation 806 cross-checks the suspected unreported drivers against any exclusions listed in the policy of the policyholder. If such an exclusion is present, this indicates that the unreported driver is purposefully excluded from the policy. This can happen, for example, if the excluded driver owns their own insurance policy. The comparison operation 806 excludes the unreported driver from the system, ensuring that they will not appear in an output record.

A prioritization operation 808 determines the rateability of the unreported driver based on one or more characteristics of the unreported driver and the matched policyholder. For example, a surname match would indicate that the policyholder and unreported driver can be in the same family, raising the probability that the unreported driver should be reported to the policyholder's insurer and included on the policy. A match between the unreported driver's license address and the policyholder's insurer address can also increase this confidence. Other possible filters can be used to increase the probability that the unreported driver should be reported to the insurer. Additionally, any combination of filters can be combined to increase accuracy. This allows insurers to contact high-priority (due to higher confidence) unreported drivers first, allowing insurers to allocate resources more efficiently. If the insurer has limited time to contact policyholders regarding unreported drivers, they can choose to contact only those where the uninsured driver has an address and surname match or other combination of filters, so they most probably should be included on the policy of the policyholder.

The prioritization operation can also exclude records based on user preferences. Insurers can find that certain correspondences are sufficiently reliable indicators that they do not want to know about records that lack such a correspondence. The insurer can choose to exclude such records altogether rather than simply seeing those records as being of lower priority. Alternately, the file generation operation 810 can exclude the records.

A file generation operation 810 generates an output record (such as those shown in FIG. 5 or FIG. 7). The operation 810 incorporates information regarding the unreported drivers not excluded by the comparison operation 806 or the prioritization operation 808. The operation 810 can generate a printed record or a data file of a variety of formats, such as a text file, a Microsoft Word document, a WordPerfect Document, a hypertext markup language (HTML) document or a different proprietary format. The file can include a wide variety of information about the unreported driver and the matched policyholder, and can be limited only by the thoroughness of the initial input data received from the state and from the insurer. Such information can include the surname of the policyholder, insurance agent information, and various unreported driver information (as shown in FIGS. 5 and 7, above). The file generation operation 810 can exclude records from the output report based on user preferences if the records are not excluded prior to file generation.

A summary module 812 determines whether a summary report was requested by the user of the system. If a summary report is requested, a summary report operation 814 generates a summary report. The summary report can contain statistics and raw data (as is seen in FIG. 6, above) that provide a shorter overview of the contents of the output record. In this way, an insurer can receive fast feedback regarding the results of the system.

If a summary report is not requested, the summary module directly passes control to an end operation 816. Regardless of whether the summary report is requested, the system is terminated with the end operation 816.

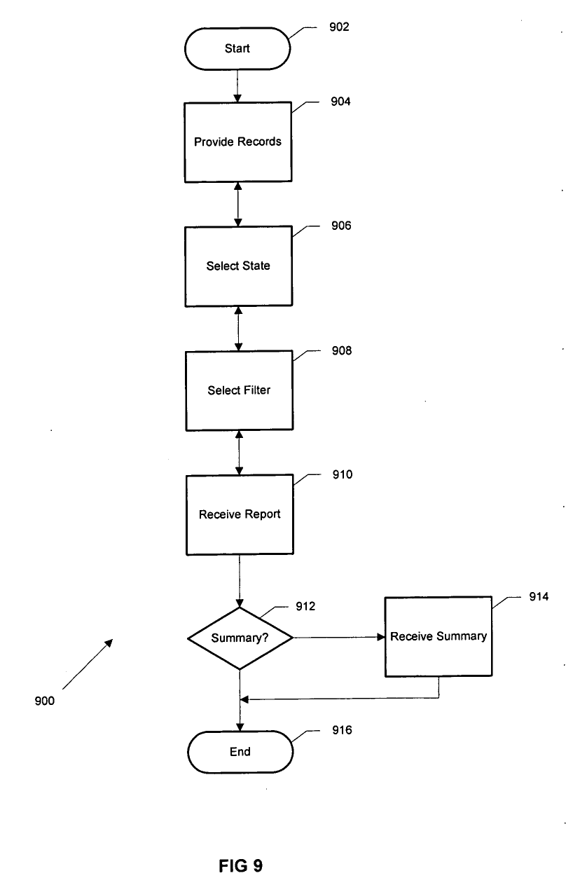

Referring now to FIG. 9, an unreported driver exposure reduction system 900 is shown according to another possible embodiment of the present disclosure. The system commences with a start operation 902.

A provide records operation 904 provides policyholder records to the system. These policyholder records include policyholder names, addresses, and in the case of automobile insurance policies, additional drivers included on the policy.

A state selection operation 904 chooses which state's data should be checked against the provided records. In the case where the state hosts the risk detector, this state selection operation 904 is accomplished by providing the policyholder records to the state of choice. In the case where a non-governmental entity hosts the system, the state selection operation 906 is accomplished by indicating to the system which state is desired. The system requests the needed records from the state.

A select filter operation 908 chooses one or more rateability characteristics with which to filter results. The filter operation 908 can prioritize certain results that have the selected characteristic, or it can exclude results that lack that characteristic. Characteristics include matched surnames, matched policy and state license addresses, or other comparable data between the provided policyholder records and data stored by the state selected by the state selection operation 906.

A receive report operation 910 receives an output record including one or more unreported drivers corresponding to one or more of the policyholders listed in the policyholder records provided by the provide records operation 904. The output record can include a variety of other information about the unreported driver and the policyholder to whom the unreported driver corresponds.

The receive report operation 910 can also only include unreported drivers that received driving permits more than a user-selectable number of months ago. This user selection permits users of the system, who are often insurers, to choose to hear about unreported drivers a few months after that driver appears in the state driver licensing records. Because there is sometimes a lag time between when the driver is entered into the state driving records and when the insurer wants to have that driver included on the policy of a policyholder, insurers can elect to delay record delivery in this manner.

The receive report operation 910 can be executed in a wide variety of ways consistent with the present disclosure. For example, a user of the system can be an insurer, and individual insurance agents can receive the output record for their client policyholders by accessing an electronic document, for example across a HTTPS secure network connection to the host of the system. Additionally, the user of the system can be sent a paper or electronic file that they can use or disseminate as needed.

A summary module 912 allows a user the option of selecting a summary report. If a summary report is requested, a summary report operation 914 receives a summary report. The received summary report can appear as in FIG. 6, above.

If a summary report is not requested, the summary module directly passes control to an end operation 916. Either way, the system is terminated with the end operation 916.

The systems described above, operated on a computing system such as the one described in FIG. 2, can be implemented in a wide variety of programming languages, such as JAVA, C++, Pascal, COBOL, PERL, Visual BASIC, or other languages. Languages containing constructs allowing for handling of large quantities of data and quick comparison of strings are particularly useful for implementing aspects of the present invention, as the policyholder records and the state driver licensing data generally are sizable.

Furthermore, because the system operates by checking each policy against all of the provided state records, the system potentially has a complexity of order O(m×n) in the comparison unit, where m is the number of policyholders and n is the number of state records. A wide variety of programming constructs can increase the system efficiency. The system can execute the comparisons sequentially or using an appropriate language could use a series of threads, passing data among the threads as needed. For example, each of the operations in FIG. 8 could operate using a dedicated thread to generate a pipelined effect and increasing throughput of the system. Alternately, each thread could be provided one policyholder to check against the state data. In this case, each policyholder thread would be of order O(n), and multiple threads could operate concurrently on the same system with minimal overhead for data consistency because the formatted state records as input into the comparison unit are not altered.

Consistent with and inherent in the present disclosure, additional comparisons between insurer records and state data can be accomplished. For example, such systems can be useful to insurers of large corporations who wish to cross-check state criminal records with entries in employer insurance policies. Additionally, state health data can correlate well to health insurance records, or state death records can correspond to life insurance policies.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A system for detecting unreported exposures comprising:
(a) a load unit configured to accept state records;
(b) a risk determination unit operatively connected to the load unit, the risk determination unit comprising a comparison module and a rateability module, wherein the comparison module matches an address in the state records to a state policyholder address to find one or more unreported exposures, and wherein the rateability module prioritizes the unreported exposures based on a correspondence to a record of a policyholder; and
(c) a report unit operatively connected to the risk determination unit, the report unit configured to compile an output record of the one or more unreported exposures.

2. The system of claim 1 wherein the one or more unreported exposures is a new driver.

3. The system of claim 2, wherein the rateability module determines the correspondence by comparing a surname of a policyholder to a surname of the new driver.

4. The system of claim 1, wherein the rateability module determines the correspondence by comparing an insurer policyholder address to the address in the state records.

5. The system of claim 1, wherein the report unit is capable of generating a summary report of the one or more unreported exposures.

6. A system for detecting unreported drivers comprising:
(a) a load unit configured to accept state driver licensing data;
(b) a risk determination unit operatively connected to the load unit, the risk determination unit comprising a comparison module and a rateability module, wherein the comparison module matches an address in the state driver licensing data to a policyholder license address to find one or more unreported drivers, and wherein the rateability module prioritizes the one or more unreported drivers based on a correspondence to policyholder records; and
(c) a report unit operatively connected to the risk determination unit, the report unit configured to compile an output record including the one or more unreported drivers.

7. The system of claim 6 wherein the system can operate on all policyholder records or a specific set of policyholder records.

8. The system of claim 6 wherein the load unit is configured to accept state driver licensing data of multiple formats.

9. The system of claim 6 wherein the load unit is configured to accept partial state driver licensing data.

10. The system of claim 6 wherein the comparison unit excludes an unreported driver if the unreported driver matches an exclusion listed in the policyholder records related to the policyholder.

11. The system of claim 6 wherein the rateability module determines the correspondence to the policyholder records by comparing a surname of an unreported driver to a surname of a policyholder.

12. The system of claim 6 wherein the rateability module determines the correspondence to the policyholder records by comparing the license address in the state driver licensing data to an insurer policyholder address.

13. The system of claim 6 wherein the rateability module excludes an unreported driver based on a lack of correspondence to the policyholder records.

14. The system of claim 6 wherein the report unit stores the output record for a selectable number of months.

15. The system of claim 6 wherein the report unit is capable of categorizing an unreported driver according to one or more age groups of unreported drivers.

16. The system of claim 6 wherein the report unit is capable of categorizing an unreported driver according to the correspondence to policyholder records.

17. The system of claim 6 wherein the report unit includes in the output record insurance agent information corresponding to each policyholder.

18. The system of claim 6 wherein the report unit includes in the output record a driver status indicator.

19. The system of claim 6 wherein the report unit is capable of compiling a summary report of the output record.

20. The system of claim 19 wherein the report unit is capable of including in the summary report one or more statistical categories related to the correspondence to policyholder records.

21. A method of reducing unreported driver exposures comprising:
receiving state driver licensing data;
comparing the state driver licensing data to insurer license data to detect one or more unreported drivers listed in the state driver licensing data;
prioritizing the one or more unreported drivers based on at least one rateability characteristic;
generating an output record containing a listing of the one or more unreported drivers.

22. The method of claim 21 further comprising generating a summary report of the contents of the output record.

23. The method of claim 22 wherein the summary report includes statistics regarding the one or more unreported drivers.

24. The method of claim 21 wherein the output record comprises a data entry including information relating to a policyholder and the one or more unreported drivers.

25. The method of claim 24 wherein the output record includes a surname of the policyholder.

26. The method of claim 21 wherein the output record includes insurance agent information.

27. The method of claim 21 wherein the state driver licensing data is an entire state license database.

28. The method of claim 21 wherein the state driver licensing data is a new driver update to a state license database.

29. The method of claim 21 wherein the state driver licensing data is a pointer to a state license database.

30. The method of claim 21 wherein the rateability characteristic comprises a surname match between the one or more unreported drivers and a policyholder.

31. The method of claim 21 wherein the rateability characteristic comprises an address match between a license address of the one or more unreported drivers and a policy address of a policyholder.

32. The method of claim 21 wherein the generating step further comprises excluding the one or more unreported drivers based on an absence of one or more rateability characteristic.

33. The method of claim 21 wherein the generating step categorizes the one or more unreported drivers based on the prioritizing step.

34. The method of claim 21 wherein one or more steps are performed by a state agency.

35. A computer-readable medium having computer executable instructions for reducing exposure to unreported drivers comprising:
receiving state driver licensing data;
comparing the state driver licensing data to insurer license data to detect at least one unreported driver listed in the state driver licensing data;
prioritizing the at least one unreported driver based on at least one rateability characteristic;
generating an output record containing a listing of the at least one unreported driver.

36. The computer-readable medium of claim 35 further comprising generating a summary report of the contents of the output record.

37. The computer-readable medium of claim 35 wherein the rateability characteristic comprises a surname match between the at least one unreported driver and a policyholder.

38. The computer-readable medium of claim 35 wherein the rateability characteristic comprises an address match between a license address of the at least one unreported driver and a policy address of a policyholder.

39. The computer-readable medium of claim 35 wherein the generating step categorizes one or more of the at least one unreported driver based on the prioritizing step.

40. The computer-readable medium of claim 35 wherein the generating step excludes one or more of the unreported drivers based on the prioritizing step.

41. A method of reducing exposure to unreported drivers comprising:
providing policyholder records;
selecting a state in which to detect unreported drivers at the same driver's license address as one or more policyholders;
selecting a rateability filter to increase accuracy of results;
receiving an output record containing state driver licensing data corresponding to the unreported drivers.

42. The method of claim 41 wherein the rateabilility filter comprises a policy address match.

43. The method of claim 41 wherein the rateabilility filter comprises a surname match.

44. The method of claim 41 wherein the output report is categorized by age group of the unreported drivers.

45. The method of claim 41 further comprising receiving a summary report.

46. The method of claim 45, wherein the summary report includes a count of the unreported drivers contained in the output report.

47. The method of claim 41 wherein the receiving step comprises accessing networked content using a secured communication protocol.
